(19) United States
(12) Patent Application Publication
(10) Pub. No.: US 2012/0279345 A1
(43) Pub. Date: Nov. 8, 2012

(54) TRANSLATABLY AND ROTATABLY SEMI-ACTIVE DEVICE

(75) Inventors: Arvid Bergander, Dresden (DE); Jose Lozada, Massy (FR); Tobias Poessinger, Ettal (DE); Samuel Roselier, Le Rheu (FR)

(73) Assignee: Commissariat a l'energie atomique et aux energies, Paris (FR)

(21) Appl. No.: 13/511,526

(22) PCT Filed: Nov. 23, 2010
(86) PCT No.: PCT/EP10/68041

§ 371 Date: May 23, 2012

(30) Foreign Application Priority Data
Nov. 25, 2009 (FR) 09 58352

(51) Int. Cl. F16F 9/53; G05G 1/30

(52) U.S. Cl. 74/512; 188/267.2

(57) ABSTRACT

A semi-active device capable of generating a resistive force against movements of a mobile element (2) of longitudinal axis (X) capable of moving in translation along its axis (X) and in rotation about said axis (X) in a housing(4), said housing (4) delimiting with the mobile element (2) a sealed annular space (8), said annular space being filled with magneto-rheological fluid, the device also comprising means for generating a magnetic field in said annular space (8) comprising four electromagnets each comprising a coil (30) and a core (32), the cores (30) directly forming the housing (4).

### TECHNICAL FIELD AND PRIOR ART

The present invention relates to a device that is semi-active in translation and rotation, capable of generating resistance to linear and rotational movements by modifying the apparent viscosity of a magneto-rheological fluid controlled by modulation of a magnetic field.

A device is said to be semi-active when it is only capable of absorbing energy.

Semi-active devices can be used in tactile simulation systems or haptic systems which give feedback on a command given by a manual control, or they can be used in motor vehicle suspension systems.

Said devices comprise a mobile element in contact with a magneto-rheological fluid, whose movement is braked when the apparent viscosity of the fluid increases.

There exist linear braking devices in which the element is mobile solely in translation. In this case, the element has a rectangular section, the guiding and dynamic sealing of such an element are difficult to achieve. In addition, these devices do not allow movement in rotation.

Document FR 2902538 describes a musical instrument comprising a simulation device using a blade mobile in a magneto-rheological fluid. This device does not allow the generating of resistance to rotational movements. In addition, its fabrication is complex in terms of guidance and sealing. Also the blade has low rigidity and is therefore difficult to integrate in complete systems.

There also exist linear brake whose coefficient of braking can be controlled in relation to demand placed thereupon by a control system. These only operate in translation and the amplitude of movement is limited.

Rotating semi-active brakes also exist which have the disadvantage that their construction is relatively complex and they are cumbersome.

### DISCLOSURE OF THE INVENTION

It is therefore an objective of the present invention to provide a semi-active device capable of generating a force resisting both translation and rotation that is of simple build and compact.

This stated objective is achieved with a semi-active device comprising a mobile element with circular cross-section, of longitudinal axis capable of moving about its axis and along its axis and received in a housing of mating shape, a magneto-rheological fluid filling the space between the housing and the mobile element, the housing being delimited directly by means for generating a magnetic field through the fluid. The means for generating the magnetic field are such that they generate a magnetic field through the magneto-rheological fluid causing the onset of shear forces on the surface of the mobile element.

In particularly advantageous manner, the field lines are oriented radially so that they lie orthogonal to the surface of the mobile element, the braking force thereby being increased.

The means for generating the magnetic field can be formed by pairs of electromagnets diametrically opposite two by two relative to the mobile element.

The device can also be associated with an actuator capable of moving the mobile element.

The present invention relates to a semi-active device capable of generating a force resisting motion of a mobile element, comprising:

said mobile element of longitudinal axis provided with at least one part having a circular cross-section;

a body delimiting a housing of longitudinal axis receiving said part of the mobile element having a circular cross-section so that the mobile element is capable of moving in translation along its axis and in rotation about said axis (X) in the housing;

means for generating a magnetic field in said annular space, said magnetic field generating means comprising at least one electromagnet, said at least one electromagnet comprising a coil and a magnetic core, said housing being formed directly in said magnetic core;

means for controlling said means for generating the magnetic field;

two end flanges longitudinally delimiting the housing for sealed closing of the annular space, each flange being provided with a passage in which the mobile element slides and pivots in sealed manner, the longitudinal ends of the mobile element being located outside said housing;

sealing means arranged in the passages and ensuring a seal by friction with the mobile element, said housing delimiting with the mobile element a sealed annular space;

a magneto-rheological fluid filling said annular space and forming an annular layer around the mobile element;

rings for guiding the mobile element in the housing, said guide rings being fixed in the housing and being in contact with the part of circular cross-section of the mobile element, said rings defining the thickness of the annular space.

Preferably, the coils are oriented so that the generated fields are oriented radially relative to the mobile element.

Advantageously the annular space is of substantially constant thickness. For example the thickness of the annular space is between 200 μm and 2 mm.

The semi-active device comprises for example at least one pair of electromagnets diametrically opposite two by two relative to the mobile element, said control means controlling the current supply so that the poles of the diametrically opposite electromagnets, oriented on the side of the mobile element, are of opposite polarity.

In one example of embodiment, the semi-active device comprises at least two pairs of electromagnets diametrically opposite two by two relative to the mobile element. Advantageously said control means control the current supply so that the pole of each electromagnet oriented on the side of the mobile element is surrounded by two poles of adjacent electromagnets of opposite polarity.

For example, the cores in magnetic material comprise a curved face each forming an angular portion of the housing over its entire height.

Advantageously, the body of the semi-active device is formed directly by the magnetic core(s).

The semi-active device may comprise several magnetic cores in the form of angular sectors secured to one another. The end flanges then advantageously ensure the securing of the magnetic cores, and the seal of the body of the device is obtained by means of a sealant arranged on an outer surface of the cores.

Alternatively, the cores of all the electromagnets are in one single piece.

In another example of embodiment, the semis-active device may comprise at least one permanent magnet arranged in one of the magnetic circuits of each of the electromagnets.

The mobile element may for example be a tube.

A further subject-matter of the present invention is an active device comprising a semi-active device according to the present invention and an actuator through which the mobile element passes. The actuator may comprise one stage provided with at least two electromagnets diametrically opposite relative to the mobile element, and another stage provided with at least two electromagnets diametrically opposite relative to the mobile element, and the portion of the mobile element passing through the actuator comprising two zones of opposite polarity in axial sequence.

A further subject-matter of the present invention is a control system intended for a motor vehicle, comprising at least one pedal controlling a system of said motor vehicle, and at least one semi-active device according to the present invention, the mobile element being linked to said pedal to apply a force against motion of said pedal.

A further subject-matter of the present invention is a control system comprising a control member intended to be handled by an operator and via which the operator transmits commands, and a first and a second semi-active device according to the present invention, said control member being fixed to one end of the mobile element of the first semi-active device, said element being mobile along and about a first axis, said mobile element being secured to the mobile element of the second semi-active device, said element being mobile along and about a second axis, the first and second axes being perpendicular, the control member then being capable of moving along and about the first and second axes perpendicular to each other.

### BRIEF DESCRIPTION OF THE DRAWINGS

The present invention will be better understood with the help of the following description and appended drawings in which:

FIG. 1 is a longitudinal section view of an example of embodiment of a semi-active device according to the present invention;

FIG. 2 is detail view of FIG. 1;

FIG. 3A is a view of an isolated part of the device in FIG. 1;

FIG. 3B is a perspective view of an element of the means for generating a magnetic field, used in a semi-active device;

FIG. 3C is a variant of embodiment of the element in FIG. 3B;

FIG. 4 is a cross-sectional view along plane A-A of the device in FIG. 1 at the magnetic field generating means;

FIG. 5 is a schematic illustration of the field lines of the magnetic field generated by the magnetic field generating means in FIG. 4;

FIG. 6 is a cross-sectional view of another example of means for generating a magnetic field;

FIG. 7 is a cross-sectional view of a variant of embodiment of the device;

FIG. 8A is a cross-sectional view of another example of means for generating a magnetic field;

FIG. 8B is a cross-sectional view of a variant of the device in FIG. 8A;

FIG. 9 is a longitudinal section view of an example of embodiment of a device capable of applying a resistive force to the mobile element for braking the movement thereof, and a motor force to cause it to move;

FIGS. 10A to 10E are examples of application of the semi-active device according to the invention;

FIG. 11 is an overhead view of another example of embodiment of a semi-active device.

### DETAILED DESCRIPTION OF PARTICULAR EMBODIMENTS

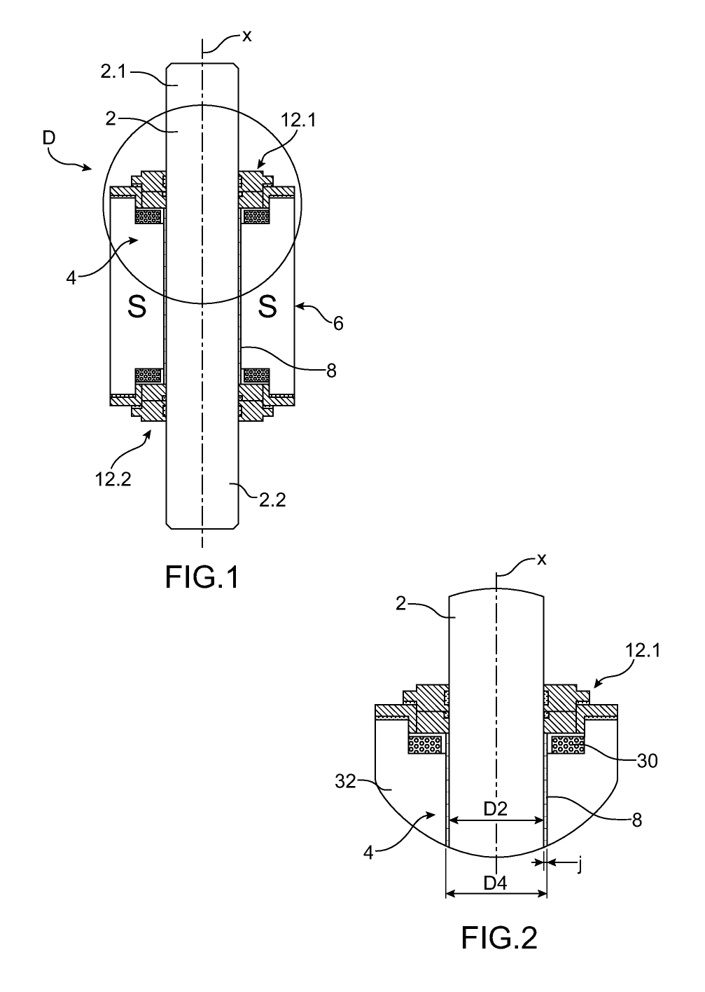

In FIG. 1, an example of embodiment of a semi-active device D according to the present invention can be seen.

The device is intended to form a haptic interface for example, or tactile simulation system e.g. in a braking system.

The semi-active device D comprises a mobile element 2, a body in which a housing 4 is formed receiving the mobile element 2, and means for generating a magnetic field 6 inside the housing 4.

The mobile element 2 is intended to be mechanically linked to an external element via one of its longitudinal ends 2.1, 2.2, for example to a handle of a joystick-type control system, or a brake pedal intended to be handled by an operator, or a stub axle of a motor vehicle wheel for a suspension system.

The mobile element 2 is of elongate shape of longitudinal axis X and has a circular cross-section of outer diameter D₂. The housing 4 has a circular cross-section corresponding to that of the mobile element 4 and of inner diameter D₄, D₄ being larger than D₂.

FIG. 2 shows a detail of the device in FIG. 1. A clearance j is provided between the outer surface of the mobile element 2 and the surface of the housing 4 defining an annular space 8. This clearance is advantageously of the order of 1 mm. The clearance 1 is advantageously between 200 μm and 2 mm.

Preferably the clearance j is identical or substantially identical over the entire height of the housing, allowing homogeneous distribution of the resistive forces applied to the mobile element 2. The mobile element 2 is capable of sliding along the axis X and of pivoting about the axis X.

The mobile element 2 is preferably made in magnetic material.

In the illustrated example, the housing 4 surrounds the mobile element 2 over only one longitudinal portion, the longitudinal ends 2.1, 2.2 of the element being located outside the housing 4.

It is not necessary for the mobile element to have a circular cross-section over its entire length, it may have this cross-section over only one part, the part intended to enter inside the housing.

The housing is delimited directly by the means capable of generating a magnetic field 6 and by two flanges 12.1, 12.2 of annular shape fixed to each of the longitudinal ends of the magnetic field generating means. The two flanges 12.1, 12.2 are advantageously in non-magnetic material to prevent short-circuiting of the magnetic flow. The two flanges form end caps.

The two end flanges 12.1, 12.2 being similar, only flange 12.1 will be described in detail.

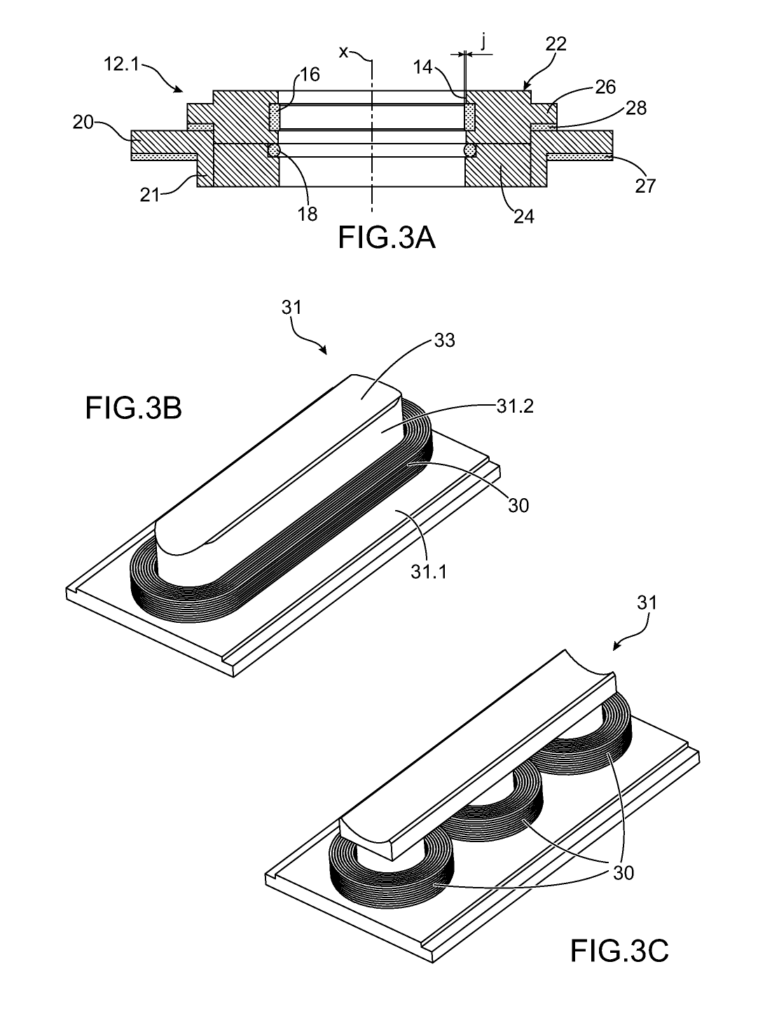

Flange 12.1, which can be more clearly seen in FIG. 3A, comprises a central passage 14 in which the mobile element 2 is mounted capable of sliding and pivoting in sealed manner.

The device comprises means for guiding the mobile element both in translation and in rotation so as to maintain substantially constant the clearance j between the mobile element 2 and the housing 4. In the illustrated example, these guide means are formed by two guide rings 16 one arranged in flange 12.1 and the other in flange 12.2, simplifying the positioning thereof. FIG. 3 shows a magnified view of the flange 12.1 and of the clearance j arranged between the housing 4 and the mobile element.

However provision could be made to arrange one or more guide rings inside the housing in contact with the electromagnets. A device with more than two rings does not depart from the scope of the present invention.

The ring 16 is mounted in a groove made in the surface of the central passage 11. The ring 16 may advantageously be made in a material having good anti-adhesion properties such as Teflon®. It is to be noted however that magneto-rheological fluids contain oil of which a small amount crosses the barrier of the sealing gaskets described below and lubricates the guide rings.

A sealing gasket 18 is mounted in a groove of the surface of the central passage 14 capable of ensuring dynamic sealing with the surface of the mobile element 2. For example this may be an O-ring e.g. in nitrile or a lip seal.

Sealing is provided both in rotation and in translation by friction at each longitudinal end of the housing, which simplifies the manufacture of the semi-active device.

In the illustrated example, the end flange 12.1 is composed of a first part 20 formed by an annular plate 20 bordered at its inner diameter by a tubular section 21, and a second part 22 comprising the central passage 14, which is mounted in the first part 20. The second part 22 comprises at least one portion 24 whose outer diameter is substantially equal to the inner diameter of the tubular section 21, this portion 24 being arranged in the tubular section 21 of the first part 20. The second part 22, on its outer surface, also comprises a radial projection 26 intended to come to bear via one face on the first part 20. A seal 28 is provided between the annular projection 26 and the first part of the flange 20.1, capable of ensuring a static seal, for example it may be a flat seal. A seal 27 is also arranged between the first part 20 and the body formed by the magnetic field generating means.

In the illustrated example, the second part 22 is composed of two elements, allowing better controlling of the force on the O-ring 18 and hence of sealing with the mobile element 2.

Provision could be made to form each flange 12.1, 12.2 in a single piece for easier assembly and not requiring the seals 28.

The housing 4, with the element 2, therefore defines a fluid-tight space 8.

The annular space 8 is filled with a magneto-rheological fluid such as MRF-140CG marketed by Lord Corporation.

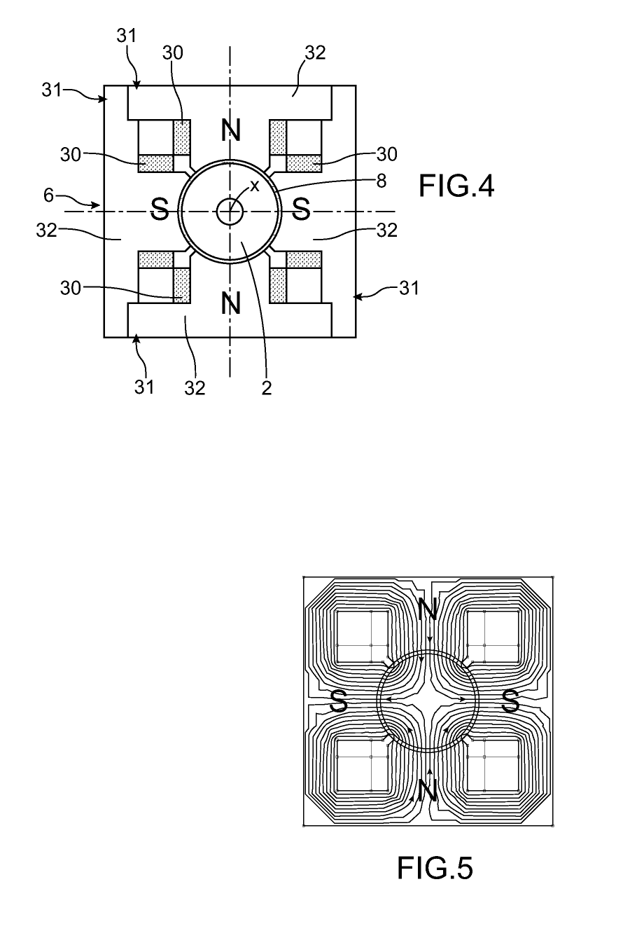

In the example illustrated in FIG. 1, the magnetic field generating means are composed of four electromagnets (FIG. 4) each formed of a coil 30 and an element in magnetic material 32 arranged in the coil 30. The elements in magnetic material 32 will be designated the <<cores>> in the reminder hereof.

The electromagnets are arranged diametrically opposite, two by two, relative to the mobile element 2. Advantageously, the axis of each of the coils 30 is oriented radially relative to the mobile element 2, so that the field lines of the generated magnetic field are substantially orthogonal to the lateral surface of the mobile element 2. This orthogonal orientation of the field increases the shear forces opposing the motion of the mobile element.

In the illustrated example, the cores 32 directly delimit the housing of the mobile element 2, the magneto-rheological fluid being in contact with the cores. This configuration allows a reduction in the reluctance of the magnetic circuit. The supply current can then be reduced as well as the diameter of the coil wires, for better compactness.

In addition, advantageously, the cores form the body of the device which allows a reduction in the necessary parts, the size of the device and the cost thereof. It is then not necessary to provide for an additional casing to receive the cores. The cores are secured together by the flanges 12.1, 12.2 for example and/or by screwing. The assembly is then sealed e.g. on the outer surface of the body by means of a sealant. This avoids having to insert seals between the cores and perturbing the guiding of the field lines.

In the illustrated example, the body is in the shape of rectangular parallelepiped of longitudinal axis X and of square cross-section.

The body delimits the housing 2 of axis X.

In the illustrated example, the body is formed of four identical angular sectors 31 each forming a core. The sectors 31 are obtained by cutting the body at the diagonals of the square section.

Each angular sector 31 extends over the entire height of the body.

In FIG. 3B, an angular sector 31 can be seen in perspective. It comprises a first part of larger section 31.1 forming the outer wall of the body and a part of smaller section 31.2 delimiting the housing 4.

The part of smaller section 31.2 comprises a face 33 formed of an angular portion of a tube having a radius of curvature D₄/2. The four faces then form a closed cylindrical surface delimiting the housing 4.

Each coil 30 is arranged about the second part of smaller section 31.2 of a core, capable of generating a magnetic field whose field lines 35 are guided by the cores 32.

In the illustrated example, the coils extend over the entire height of the housing. In FIG. 3C, a variant of embodiment can be seen of an angular sector 31 comprising several coils 30 arranged beside each other along the mobile element. These coils create a high, homogeneous magnetic flow in the magneto-rheological fluid contained between the mobile element and the surface of the housing.

The coils can be mounted electrically in series and magnetically in parallel, this having the advantage of allowing operation at lower currents.

As can be seen in FIG. 5, the pathway of the field lines 35 is the following. They circulate through the cores 30, the magneto-rheological fluid, the mobile element 2, the magneto-rheological fluid once again, the two directly adjacent cores and then close on their core. Part of the field lines 35 of one same coil is guided by the core located overhead in FIG. 4 and one part is guided by the core lying underneath.

By means of the particular shape of the cores, the magnetic circuits are closed and allow very good guiding of the magnetic flow to be obtained avoiding leakages.

Advantageously, the cores surrounding the mobile element are alternately North and South.

The polarities illustrated in the figures are shown solely as an example, since for coils the orientation of the polarity depends on the direction of circulation of the current, and can therefore be easily reversed by reversing the direction of current circulation. The direction of current circulation is therefore advantageously chosen so that the polarities are alternated around the mobile element.

It is to be noted that only the pole of each core located on the side of the mobile element is illustrated, but evidently each core comprises two poles of opposite polarity when a current circulates in its surrounding coil.

The circulation of the field lines from North pole to South pole is symbolized by arrows.

The magnetic field modifies the apparent viscosity of the fluid. The increase in apparent viscosity generates shear forces between the mobile element 2 and the surface of the housing delimited by the cores, causing a force resisting motion of the mobile element, in translation and in rotation.

As can be seen in FIG. 5, the field lines are advantageously oriented orthogonal to the surface of the mobile element 2, increasing the shear forces applied to the surface of the mobile element 2.

Evidently, the cores can be formed in a single piece e.g. by casting, or they can be formed of a stack of metal sheets. In this case, the assembly is further simplified.

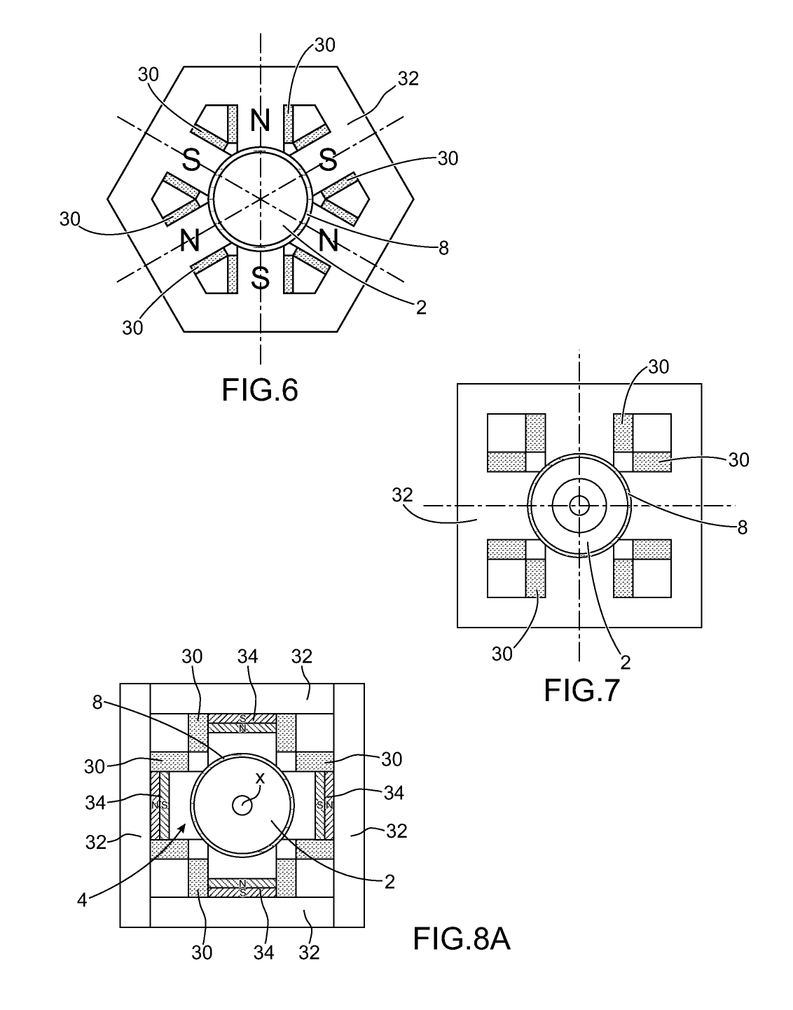

In FIG. 6, another example of embodiment can be seen of the magnetic field generating means. In this example, they comprise six coils 30 and six cores 32 diametrically opposite two by two. In the illustrated example, the cores are made in a single piece. A device comprising more than six electromagnets does not depart from the scope of the present invention.

This configuration has the advantage of reduced volume and the possible use of a three-phase current.

Provision could also be made for an uneven number of electromagnets. It could also be envisaged to have two North poles or two South poles adjacent around the mobile element.

The device also comprises means for controlling the magnetic field generating means by controlling the current delivered to the coils. Depending on applications, the intensity of the magnetic field can be modulated as a function of a kinematic and/or dynamic magnitude representing the motion of this element or of the external member connected to the mobile element 2, such as the speed of movement or the force of movement.

By means of the invention, a linear brake is combined with rotary brake within one and the same compact device which can be rapidly and linearly controlled. In addition, this device can have an active force/passive force ratio that is very high.

By passive force is meant the external force or external torque needed to move the mobile element in the absence of a magnetic field i.e. without activation of the coils by an electric current. This force is due to friction for example between the mobile element and the guide rings and the O-rings, and the viscous friction in the magneto-rheological fluid. The active force is generated by the magnetic field.

It is sought to obtain the lowest possible passive force so that the device is the most transparent possible in the absence of a magnetic field, and the greatest possible active force so that it can oppose a wide range of external forces applied to the mobile element.

The ratio between passive force and maximum active force of the device is determined in part by the distance between the poles (N and S) and the mobile element. By reducing this distance to a few micrometers it is possible to reach a ratio of maximum active force/passive force higher than 500.

Solely as an example we will give the characteristics of a semi-active device such as illustrated in FIG. 1.

It has a height of 131 mm and width and depth of 73 mm.

The diameter of the mobile element is 28 mm and that of the housing is 30 mm, the distance between the poles of the electromagnets and the surface of the mobile element is therefore 1 mm.

The number of windings of the coils is 110.

Its weight is 5 kg.

The electric power is 40 W.

It offers a passive force of 25 N, and a maximum active force of 540 N, with a response time of 60 ms.

FIG. 11 illustrates an example of embodiment of a semi-active device from an overhead view, which comprises a single electromagnet.

In this example of embodiment the core 32 is in the shape of a ring with rectangular cross-section formed by four branches 32.1 to 32.4. The coil 30 is wound around a first branch 32.1. The housing 4 is made directly in a second branch 32.3 parallel to the first branch 32.1. The core 32 alone forms a closed magnetic circuit.

This example of embodiment is of particular interest for miniaturized systems.

In FIG. 7 a variant can be seen of a device of FIG. 1, in which the mobile element 2 is hollow, which firstly allows a reduction in the weight of the device without modifying the surface of the mobile element 2 subjected to shearing, and secondly allows release of space to house other devices such as force sensors for example or cables for functional elements arranged at the end of the mobile element 2, e.g. for optical signaling or active tactile feedback by vibratory motor.

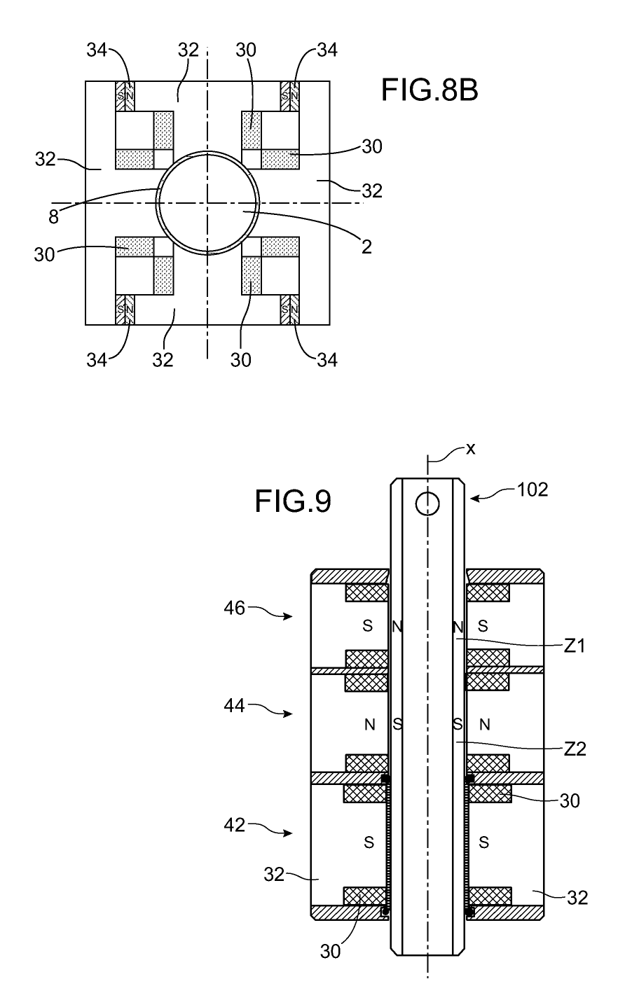

In FIG. 8A another example of embodiment of semi-active device can be seen, in which the magnetic field generating means also comprise permanent magnets 34 for which the North and South poles are designated N and S respectively.

In the illustrated example, a permanent magnet 34 is associated with each coil 30 and core 32 assembly arranged in a coil. The magnetization of the permanent magnets 34 is such that the field lines of the magnetic field they generate have substantially the same direction as those of the coils in which they are arranged.

The permanent magnets 34 generate a permanent magnetic field. Therefore, the apparent viscosity of the magneto-rheological fluid is increased, in the absence of current in the coils, thereby causing a braking force on the mobile element 2. The device is then normally blocked or at least normally braked.

This permanent magnetic field can be reduced, even cancelled, or on the contrary reinforced by the magnetic field generated by the coils.

The field lines of the permanent magnets and coils effectively have the same directions. In relation to the direction of current circulation in the coils, the magnetic fields can either add to one another, causing an increase in the resulting magnetic field, or subtract from each other causing a decrease, even the cancellation of the resulting magnetic field.

The permanent magnets 34 can be arranged at any location in the magnetic circuits defined by the cores. For example, in FIG. 8B, a variant of embodiment of the device in FIG. 8A can be seen, in which the permanent magnets 34 are not positioned in the coils but between the cores, which simplifies the manufacture of the device.

This example of embodiment has the advantage of providing a normally blocked device. In addition, the resistive force generated by the device can be increased, since the resulting magnetic field is greater than the magnetic field generated solely by the coils when the magnetic field of the permanent magnets and that of the coils are in the same direction. Or else, provision may be made to deliver the same force of resistance as that of a device in FIG. 1, in this case the energy consumption to produce this force is reduced, since part of the magnetic field is generated by the permanent magnets.

FIG. 9 shows an example of embodiment of a device 40 capable both of producing a force resisting movement in translation and rotation of the mobile element, and of producing a motor force capable of causing movement in rotation and in translation. This device is called an “active device”.

The device 40 comprises three stages. A first stage 42 similar to the device D in FIG. 1 and a second 44 and a third 46 stage forming an actuator in translation and in rotation 42.

The device 40 comprises a mobile element 102 received in a housing 104, the housing being defined by the first stage 42 and the second and third stages 44, 46. The three stages 42, 44, 46 are arranged along the axis X, the second and third stages being contiguous.

The second and third stages are of similar structure to the structure of the magnetic field generating means in FIG. 1. Each comprises four coils each having a core delimiting the housing.

The powering of the coils is such that when the actuator is active, the poles of the second stage and of the third stage are offset at an angle so that a South pole lies above a North pole, and conversely, in the illustration in FIG. 8.

In addition, the mobile element 102 is magnetized at its portion 48 capable of sliding at actuator level. The portion 48 comprises two contiguous axial zones Z1, Z2 of opposite polarity.

In the illustrated example, zone Z1 at the third stage forms a North pole and the zone at the second stage forms a South pole. For example, this portion of the mobile element 2 can be formed of a permanent magnet of tubular shape.

The portion of element 102 at the first stage 42 is not magnetized but is in magnetic material.

Only the first part is filled with magneto-rheological fluid. For example, a sealing gasket is arranged between the first and second stages.

An explanation will now be given of the functioning of this device.

The device 40 functions in the same way as the device in FIG. 1, a current circulates in the coils, which generates a magnetic field passing through the magneto-rheological fluid, causing an increase in the apparent viscosity thereof and hence the onset of resistance to motion both in translation and in rotation.

If the device functions as an actuator, when rotation of the mobile element 102 is desired, the poles of the two stages are powered and magnetization of the cores occurs. When the poles are identical, they repel each other and the element rotates, when the poles are opposite they attract each other. However, at the other stage the polarities are offset by π/2, which means that there are always two identical opposite-facing poles causing rotation of the element 2.

The current direction is chosen in relation to the desired direction of rotation.

For movement in rotation, the coils of the two stages are powered so that the two stages have opposite polarities. If it is desired that the mobile element 2 should move upwardly, the polarity of the second stage will be South repelling zone Z2 of the opposite-facing mobile element, and the polarity of the third stage will be North attracting zone Z2.

If it is desired to move the mobile downwardly, the direction of the current in both stages is reversed.

This device is relatively simple to produce since the actuator-forming stages are of identical design to the brake-forming stage, only the mobile element is modified.

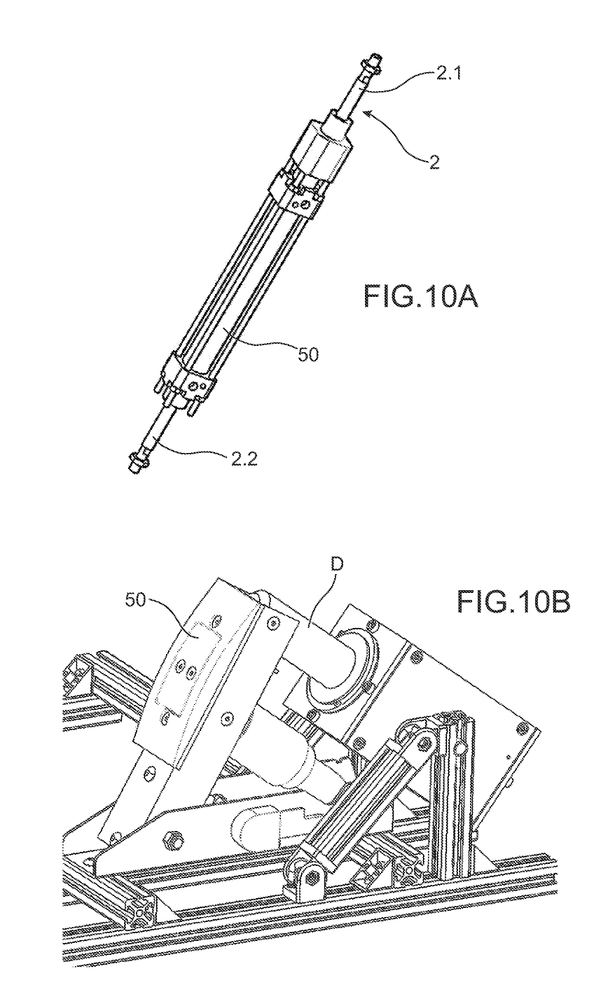

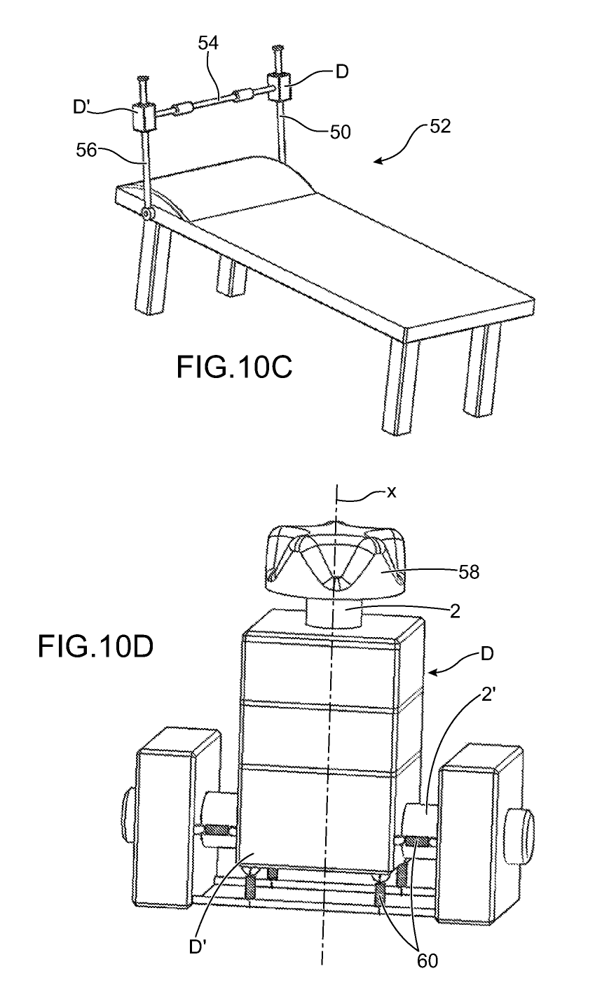

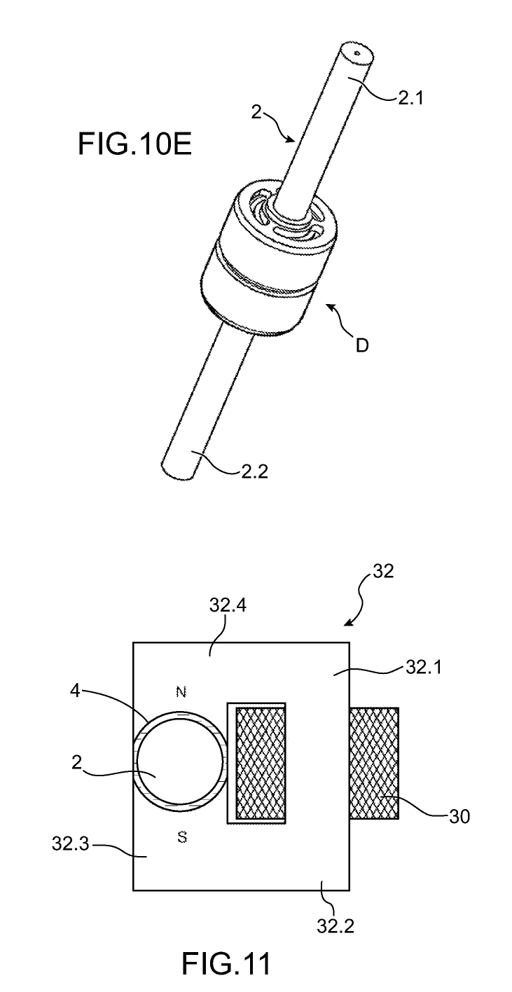

FIGS. 10A to 10E illustrate different examples of application of the device according to the invention.

FIG. 10A gives a practical illustration of a semi-active device D which can be used in different applications. The two ends of a mobile element 2 can be seen projecting beyond the housing, arranged in a tubular case 49 for protection and ease of handling thereof.

FIG. 10B illustrates a simulator for motor vehicles using the brake of FIG. 10A. The device D is arranged downstream of a brake pedal 50, the mobile element 2 being linked to the brake pedal 50 and applying a force opposing the depression thereof to a greater or lesser extent. The device D simulates the reaction of the hydraulic braking circuit. The device D could be integrated in a motor vehicle with electric braking to simulate braking force, the hydraulic circuit being solely present in the event of a circuit failure. The device D can also be used for assisted driving. A PADAS (“partially autonomous driving assistance system”) may, in such case, give a haptic signal in the event of excess speed or too short a distance away from the preceding vehicle.

In FIG. 10C a weight bench 52 can be seen using two devices D. The bench comprises a dumbbell bar 54 mounted slidingly in a vertical direction along two vertical bars 56, the sliding being braked via the two semi-active devices D, the two vertical bars 56 forming the mobile elements 2. The devices simulate the weight of the discs of a dumbbell of known type, by generating a force resisting the lifting of the bar by the person exercising. The simulated weight can easily be increased by increasing the generated magnetic field. This weight bench 52 is easy to handle and takes up little space compared with those in the state of the art. In addition, it is particularly safe since users of the weight bench can no longer injure themselves when handling weights.

The functioning of this weight bench is as follows: the user lies on the bench 52, takes hold of the dumbbell bar 54 and moves it up and down against the resistive force generated by the devices D.

Advantageously, the devices also comprise permanent magnets, allowing the dumbbell bar to be held in a given position along the vertical bars.

In FIG. 10D an active knob 58 can be seen with four degrees of freedom comprising two devices D and D′ in series.

The knob 58 is fixed onto a mobile element 2, the knob 58 is therefore able to pivot on itself and to move along axis X. In addition, the device D is fixed to a second element 2′ and is able to pivot about an axis Y perpendicular to axis X and to slide along this axis Y.

The resistive forces opposing movements about and along the axis X are generated by the electromagnets of device D, and the resistive forces along and about axis Y are generated by the electromagnets of device D′. Springs 60 in the illustrated example are provided to hold the assembly in rest position.

FIG. 10E shows a brake intended to be used in a motor vehicle, the mobile element is fixed via one end 2.2 to the wheel stub axle and via the other end 2.1 to the body of the vehicle. In this case, controlling of the intensity of the magnetic field can be determined by simulating compression of a spring.

With the device of the present invention it is possible, in simple manner and within reduced space, to generate a resistive force to both rotation and translation.

1-18. (canceled)

19. A semi-active device capable of generating a resistive force to movements of a mobile element, comprising:
said mobile element of longitudinal axis provided with at least one part having a circular cross-section,
a body delimiting a housing of longitudinal axis receiving said part of the mobile element of circular cross-section so that the mobile element is able to move in translation along its axis and in rotation about said axis in the housing,
a generator of a magnetic field in an annular space between the mobile element and the body, said magnetic field generator comprising at least one electromagnet, said at least one electromagnet comprising a coil and a magnetic core, said housing being formed directly in said magnetic core,
a control device controlling said magnetic field generator,
two end flanges longitudinally delimiting the housing to close and seal the annular space, each flange being provided with a passage in which the mobile element slides and pivots in sealed manner, the longitudinal ends of the mobile element being located outside said housing,
sealing devices arranged in the passages and ensuring a seal by friction with the mobile element, said housing delimiting a sealed annular space with the mobile element,
a magneto-rheological fluid filling said annular space and forming an annular layer around the mobile element,
guide rings guiding the mobile element in the housing, said guide rings being fixed in the housing and being in contact with the part of circular cross-section of the mobile element, said rings defining the thickness of the annular space.

20. The semi-active device according to claim 19, wherein said coil is oriented so that the generated field is oriented radially relative to the mobile element.

21. The semi-active device according to claim 19, wherein the annular space has a substantially constant thickness.

22. The semi-active device according to claim 19, wherein the annular space has a thickness of between 200 μm and 2 mm.

23. The semi-active device according to claim 19, comprising at least one pair of electromagnets diametrically opposite two by two relative to the mobile element, said control device controlling the current supply so that the poles of the diametrically opposite electromagnets which are oriented on the side of the mobile element are of opposite polarity.

24. The semi-active device according to claim 23 comprising at least two pairs of electromagnets diametrically opposite two by two relative to the mobile element.

25. The semi-active device according to claim 24, wherein said control device controls the current supply so that the pole of each electromagnet oriented on the side of the mobile element is surrounded by two poles of the adjacent electromagnets of opposite polarity.

26. The semi-active device according to claim 23, wherein the magnetic cores comprise a curved face each forming an angular portion of the housing over its entire height.

27. The semi-active device according to claim 19, wherein the body of the semi-active device is formed directly by the magnetic core(s).

28. The semi-active device according to claim 27, comprising several magnetic cores in the form of angular sectors secured to one another.

29. The semi-active device according to claim 28, wherein the end flanges ensure the securing of the magnetic cores, and the sealing of the body of the body of the device is obtained by means of a sealant arranged on an outer surface of the cores.

30. The semi-active device according to claim 19, wherein the cores of all the electromagnets are in a single piece.

31. The semi-active device according to claim 19, comprising at least one permanent magnet arranged in one of the magnetic circuits of each of the electromagnets.

32. The semi-active device according to claim 19 wherein the mobile element is a tube.

33. An active device comprising a semi-active device according to claim 19 and an actuator through which the mobile element passes.

34. The active device according to claim 33 wherein the actuator comprises a stage provided with at least two electromagnets diametrically opposite relative to the mobile element and another stage provided with at least two electro-magnets diametrically opposite relative to the mobile element, and the mobile element portion passing through the actuator comprising two zones of opposite polarity in axial sequence.

35. A control system intended for a motor vehicle, comprising at least one pedal for controlling a system of said motor vehicle, and at least one semi-active device according to claim 19, the mobile element being linked to said pedal to apply a force against motion of said pedal.

36. A control system comprising a control member intended to be handled by an operator and via which the operator transmits commands, and a first and a second semi-active device according to claim 19, said control member being attached to one end of the mobile element of the first semi-active device, said element being mobile along and about a first axis, said mobile element being secured to the mobile element of the second semi-active device, said element being mobile along and about a second axis, the first and second axes being perpendicular, the control member then being capable of moving along and about the first and second axes perpendicular to one another.
